(19) United States
(12) Patent Application Publication
(10) Pub. No.: US 2024/0099508 A1
(43) Pub. Date: Mar. 28, 2024

(54) COOKING APPARATUS

(71) Applicant: SAMSUNG ELECTRONICS CO., LTD., Suwon-si (KR)

(72) Inventors: Sangwon YUN, Suwon-si (KR); Jaegyeong MA, Suwon-si (KR); Chulwoo LEE, Suwon-si (KR)

(73) Assignee: SAMSUNG ELECTRONICS CO., LTD., Suwon-si (KR)

(21) Appl. No.: 18/528,263

(22) Filed: Dec. 4, 2023

Related U.S. Application Data
(63) Continuation of application No. PCT/KR2022/008756, filed on Jun. 21, 2022.

(30) Foreign Application Priority Data
Jul. 5, 2021 (KR) 10-2021-0087603
Oct. 6, 2021 (KR) 10-2021-0132451

(51) Int. Cl. A47J 36/38; A47J 27/00; A47J 36/10

(52) U.S. Cl. CPC A47J 36/38; A47J 27/002; A47J 36/10; A47J 36/2483

(57) ABSTRACT

A cooking apparatus includes a main body including an electronic chamber and a front plate disposed on a front side of the electronic chamber, a control box detachably mounted on a front side of the front plate, the control box including a case and an inlet panel disposed on an upper portion of the case to be in communication with outside of the main body, a plate hole formed in the front plate to communicate with the control box and the electronic chamber, and a moisture inflow prevention member disposed on an upper side of the electronic chamber to prevent moisture introduced from the inlet panel from entering the electronic chamber through the plate hole.

### TECHNICAL FIELD

The present disclosure relates to a cooking apparatus having an improved structure capable of preventing moisture from entering an electronic chamber.

### BACKGROUND ART

A cooking apparatus is an apparatus for heating and cooking an object to be cooked, such as food, and may provide multiple functions related to cooking, such as heating, defrosting, drying, and sterilizing the object to be cooked. Such a cooking apparatus may include, for example, an oven, such as a gas oven or an electric oven, a microwave heating device (hereinafter referred to as a microwave), a gas range, an electric range, an over-the-range (OTR), a gas grill, or an electric grill.

Specifically, an OTR is a microwave oven that incorporates a hood function to provide ventilation in a kitchen, and is installed to minimize an installation space and also to enable food to be cooked more conveniently and efficiently. The OTR may typically be installed above a cooking apparatus, such as a gas stove or a cooktop.

The cooking apparatus may also include various electrical components and circuit boards to control the cooking apparatus. Moisture ingress into the electrical components or the circuit boards may result in malfunction, damage to parts, or mold growth. Accordingly, the cooking apparatus may require a structure to prevent moisture from entering the electrical components or the circuit boards.

### DISCLOSURE

### Technical Problem

The present disclosure is directed to providing a cooking apparatus capable of preventing moisture from being entering an electronic chamber.

### Technical Solution

One aspect of the present disclosure provides a cooking apparatus including a main body including an electronic chamber and a front plate disposed on a front side of the electronic chamber, a control box detachably mounted on a front side of the front plate, the control box including a case and an inlet panel disposed on an upper portion of the case to be in communication with outside of the main body, a plate hole formed in the front plate to communicate with the control box and the electronic chamber, and a moisture inflow prevention member disposed on an upper side of the electronic chamber to prevent moisture introduced from the inlet panel from entering the electronic chamber through the plate hole.

The moisture inflow prevention member may further include a coupling portion to be coupled to the main body, and a tray disposed adjacent to a lower end of the plate hole and to collect moisture introduced through the plate hole.

The main body may further include a top plate disposed on the upper side of the electronic chamber and a top opening formed in the top plate to communicate with the electronic chamber, and the coupling portion of the moisture inflow prevention member may be coupled to the top plate.

The top plate may further include an upper flange extending upward from an edge forming the top opening, and the coupling portion may further include a flange groove seated on the upper flange.

The top plate may further include a coupling bracket including a bracket body extending toward the moisture inflow prevention member and a bracket hole penetrating the bracket body, and the coupling portion may further include a coupling hole corresponding to the bracket hole.

The bracket body may further include a first extension extending in a first direction, and a second extension extending in a second direction intersecting the first direction, and the bracket hole may be formed in the second extension.

The front plate may further include a front opening communicating with the electronic chamber and formed on a lower side of the plate hole, and a rear flange extending rearward from an edge forming the front opening, and the tray may further include a fitting portion formed on a lower surface of the tray to allow a portion of the rear flange to be inserted.

The cooking apparatus may further include a cooking chamber partitioned from the electronic chamber within the main body, a door configured to open or close the cooking chamber, and including a latch protrusion, and a latch body disposed within the electronic chamber and configured to lock the latch protrusion, wherein a portion of the tray of the moisture inflow prevention member may be to be accommodated in the latch body.

The inlet panel may further include an inlet hole formed therein and through which air flows in from the outside of the main body, and the plate hole may guide the air has flown in from the inlet hole of the inlet panel to the electronic chamber so as to cool the electronic chamber.

The cooking apparatus may further include a guide member disposed on a lower side of the inlet panel in the case, the guide member spaced apart from a rear surface of the case and to guide moisture flowing in from the inlet panel forward.

The guide member may have a shape inclined downwardly forward.

The plate hole may be located above the guide member.

The control box may further include a bracket panel to accommodate a circuit board, the bracket panel coupled to a lower portion of the guide member to be spaced apart from the rear surface of the case, and the moisture guided by the guide member may flow downwardly between the case and the bracket panel.

The coupling portion may have a shape extending in a front-rear direction, and the tray may have a shape extending in a left-right direction.

The fitting portion may include an elastic material.

Another aspect of the present disclosure provides a cooking apparatus including a cooking chamber, an electronic chamber partitioned from the cooking chamber, a door to open or close the cooking chamber, a control box covered by the door and detachably mounted on a front side of the electronic chamber, including a case and an inlet panel to cover an upper portion of the case and allowing air to flow in from the outside, a guide hole to guide air introduced from the inlet panel to the electronic chamber, and a moisture inflow prevention member disposed on a lower side of the guide hole and configured to prevent moisture from entering the electronic chamber through the guide hole.

The moisture inflow prevention member may further include a tray provided to collect moisture introduced through the guide hole.

The control box may further include a bracket panel disposed within the case to accommodate a circuit board and a guide member coupled to an upper portion of the bracket panel, the guide member to guide moisture introduced through the inlet panel between the case and the bracket panel.

Another aspect of the present disclosure provides a cooking apparatus including a main body attached to an external structure, an electronic chamber formed within the main body to receive electrical components, a control box configured to receive a circuit board electrically connectable to the electrical components, including a case and an inlet panel disposed on an upper portion of the case and configured to communicate with the outside, and a moisture inflow prevention member provided in the electronic chamber to prevent moisture from entering the electronic chamber from the inlet panel of the control box.

The main body may include a front plate arranged between the electronic chamber and the control box, the front plate forming a plate hole communicating with the inlet panel, and the moisture inflow prevention member may be adjacent to a lower end of the plate hole.

### Advantageous Effects

According to the spirit of the present disclosure, the cooking apparatus may have an improved structure capable of preventing moisture from entering the electronic chamber.

Further, according to the spirit of the present disclosure, the cooking apparatus may capable of protecting the electrical components or the circuit boards from moisture flowing into the cooking apparatus.

### DESCRIPTION OF DRAWINGS

FIG. 1 is a perspective view illustrating a cooking apparatus according to an embodiment of the disclosure.

FIG. 2 is a bottom perspective view illustrating the cooking apparatus according to an embodiment of the disclosure.

FIG. 3 is a top view illustrating the cooking apparatus according to an embodiment of the disclosure.

FIG. 4 is a side view illustrating one side of the cooking apparatus according to an embodiment of the disclosure with an external housing removed.

FIG. 5 is a side view illustrating the other side of the cooking apparatus according to an embodiment of the disclosure with the external housing removed.

FIG. 6 is a rear perspective view illustrating a flow of air in the cooking apparatus according to an embodiment of the disclosure with the external housing removed.

FIG. 7 is a cross-sectional view illustrating the cooking apparatus according to an embodiment of the disclosure.

FIG. 8 is a rear perspective view illustrating a flow of air in a cooking apparatus according to another embodiment of the disclosure with the external housing removed.

FIG. 9 is a view illustrating an open state of a door of the cooking apparatus according to an embodiment of the disclosure.

FIG. 10 is an exploded perspective view illustrating the door, a control box, and a main body of the cooking apparatus according to an embodiment of the disclosure.

FIG. 11 is an exploded perspective view illustrating the control box and the main body of the cooking apparatus according to an embodiment of the disclosure.

FIG. 12 is a view illustrating a state in which the external housing is removed from the cooking apparatus according to an embodiment of the disclosure from the rear.

FIG. 13 is a view of a disassembled state of a moisture inflow prevention member in the cooking apparatus shown in FIG. 12.

FIG. 14 is an enlarged view of a portion of the cooking apparatus shown in FIG. 12 from another direction.

FIG. 15 is a cross-sectional view illustrating the control box of the cooking apparatus according to an embodiment of the disclosure coupled to the main body.

FIG. 16 is a perspective view illustrating the moisture inflow prevention member of the cooking apparatus according to an embodiment of the disclosure.

FIG. 17 is a bottom perspective view illustrating the moisture inflow prevention member of the cooking apparatus according to an embodiment of the disclosure.

### MODES OF THE INVENTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Furthermore, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “1^{st}” “2^{nd}” “first”, “second”, “primary”, “secondary”, and the like may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

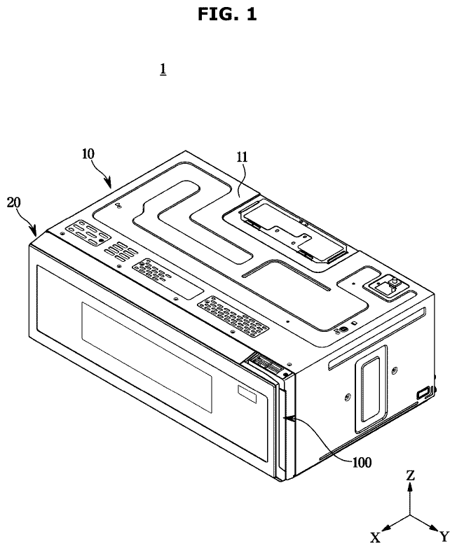

On the other hand, the terms “front and rear directions,” “front”, “rear”, “top”, “bottom”, and the like used in the following description are defined with reference to the drawings, and the shape and position of each component are not limited by these terms. For example, as shown in FIG. 1, a direction in which a door 20 faces in a cooking apparatus 1 may be defined as forward (+X direction), and the opposite direction may be defined as backward (−X direction).

Hereinafter, an embodiment of the disclosure will be described in detail with reference to the accompanying drawings.

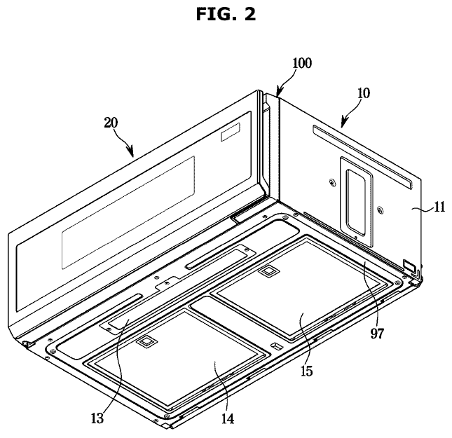

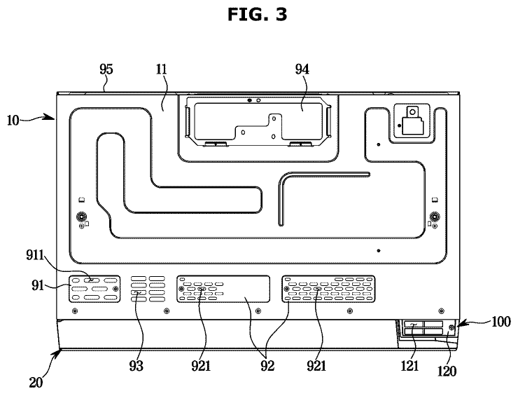

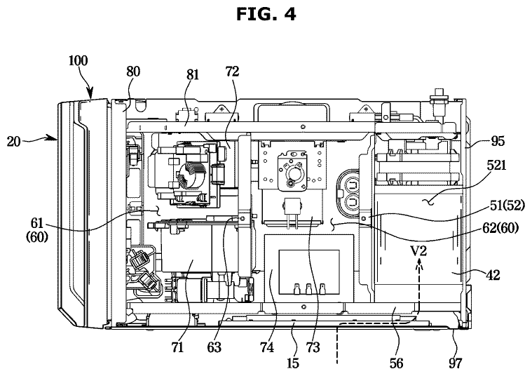

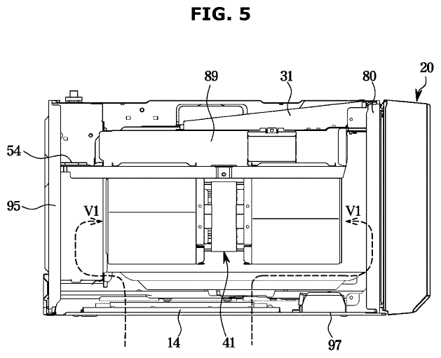

FIG. 1 is a perspective view illustrating a cooking apparatus according to an embodiment of the disclosure. FIG. 2 is a bottom perspective view illustrating the cooking apparatus according to an embodiment of the disclosure. FIG. 3 is a top view illustrating the cooking apparatus according to an embodiment of the disclosure. FIG. 4 is a side view illustrating one side of the cooking apparatus according to an embodiment of the disclosure with an external housing removed. FIG. 5 is a side view illustrating the other side of the cooking apparatus according to an embodiment of the disclosure with the external housing removed.

The cooking apparatus 1 according to an embodiment of the disclosure may be provided as an over-the-range (OTR) oven. Hereinafter, the cooking apparatus 1 will be described.

Referring to FIGS. 1 to 3, the cooking apparatus 1 may include a main body 10 and the door 20 coupled to a front side of the main body 10. The cooking apparatus 1 may include a control box 100 that may be detachably mounted on the front side of the main body 10.

The main body 10 may include an external housing 11 and an internal housing 12 provided within the external housing 11. A cooking chamber 30 and an electronic chamber 60 may be provided inside the internal housing 12. The cooking chamber 30 and the electronic chamber 60 may be arranged to be partitioned from each other.

The door 20 may be provided to open and close the cooking chamber 30. The door 20 may be rotatably coupled to the main body 10. A user may open and close the door 20 through a handle formed between the control box 100 and the door 20. The door 20 may have a rear portion, a portion of which is recessed, to cover a front side of the control box 100.

The cooking apparatus 1 may include the control box 100 that may be detachably mounted on the front side of the main body 10. The front side of the control box 100 may be covered by the door 20. In particular, the control box 100 may be coupled to the main body 10 so as to be arranged between the door 20 and the main body 10.

Referring to FIG. 2, a first circulating air intake portion 14 and a second circulating air intake portion 15 may be formed on a lower surface of the main body 10. In particular, the first circulating air intake portion 14 and the second circulating air intake portion 15 may be formed on a bottom plate 97 of the main body 10.

Contaminated air formed on a lower side of the cooking apparatus 1 may be drawn into the cooking apparatus 1 through the first circulating air intake portion 14 and the second circulating air intake portion 15. At this time, contaminated air may include oil vapor, exhaust gas, smoke, foreign substances, food odor, etc. generated in a cooking space. The first circulating air intake portion 14 may include a first circulating air inlet (not shown). The second circulating air intake portion 15 may include a second circulating air inlet (not shown).

The contaminated air drawn into the cooking apparatus 1 may be filtered by a filter (not shown) in the main body 10 and discharged to the outside of the cooking apparatus 1. The filter may be arranged to correspond to the first circulating air intake portion 14 and the second circulating air intake portion 15. Further details regarding circulating flow paths V1 and V2 of the cooking apparatus 1 will be described later.

The main body 10 may include a lighting device 13. The lighting device 13 may be disposed in front of the first circulating air intake portion 14 and the second circulating air intake portion 15. The lighting device 13 may be provided to irradiate light to the lower side of the cooking apparatus 1, for example, when a cooktop, etc. is installed below the cooking apparatus 1.

Referring to FIG. 3, a service panel 91 and a discharge panel 92 may be disposed on an upper surface of the main body 10. In particular, the service panel 91 may be detachably provided on an upper surface of the external housing 11. The discharge panel 92 may be detachably provided on the upper surface of the external housing 11.

Two discharge panels 92 are shown in the accompanying drawings, but the number of discharge panels 92 is not limited thereto.

The service panel 91 may include a first circulating air outlet 911. Each discharge panel 92 may include a second circulating air outlet 921.

A ventilation duct panel 94 may be disposed on the upper surface of the main body 10. The ventilation duct panel 94 may be removably mounted on the external housing 11.

The contaminated air introduced into the main body 10 through the first circulating air intake portion 14 and the second circulating air intake portion 15 formed on the lower surface of the main body 10 may be filtered and then discharged to the outside of the cooking apparatus 1 through the first circulating air outlet 911 and the second circulating air outlet 921.

The cooking apparatus 1 according to an embodiment of the disclosure described above is described in that the first circulating air outlet 911 and the second circulating air outlet 921 are formed in the service panel 91 and the discharge panels 92 and the filtered air is discharged into indoor spaces through the upper surface of the cooking apparatus 1.

However, the disclosure is not limited thereto and in a case where a separate communication duct (not shown) connected to the outside is provided in a space on which the cooking apparatus 1 is mounted, the service panel 91 may eliminate the first circulating air outlet 911 and the discharge panel 92 may also eliminate the second circulating air outlet 921.

Instead, a circulating air outlet (not shown) communicating with the communication duct may be formed in the ventilation duct panel 94. In this case, oil vapor introduced through the first circulating air intake portion 14 and the second circulating air intake portion 15 may be filtered, flowed into the communication duct through the ventilation duct panel 94 disposed on a rear upper surface of the cooking apparatus 1, and discharged to the outside.

The service panel 91, the discharge panel 92, and the ventilation duct panel 94 are detachably provided in the external housing 11, and the users, etc. may mount the service panel 91, the discharge panel 92, and the ventilation on the external housing 11 as needed.

More specifically, in the case where it is necessary to discharge the filtered air to indoor spaces because a separate communication duct (not shown) is not provided, the service panel 91 and the discharge panel 92 with the circulating air outlets may be mounted on the external housing 11 and the ventilation duct panel 94 without the circulating air outlet may be mounted on the external housing 11.

Conversely, if it is not necessary to discharge the filtered air to indoor spaces because a separate communication duct (not shown) is provided, the service panel 91 and the discharge panel 92 without the circulating air outlets may be mounted on the external housing 11 and the ventilation duct panel 94 with the circulating air outlet may be mounted on the external housing 11.

The control box 100 may include an inlet panel 120 provided on an upper portion of the control box 100. The inlet panel 120 may be provided to cover the upper portion of the control box 100.

The inlet panel 120 may be placed in front of the discharge panel 92. For example, the inlet panel 120 may be disposed behind a portion of the door 20. The inlet panel 120 may be accommodated in a recessed portion of the door 20 to be covered by the door 20.

Air from outside the cooking apparatus 1 may flow into the main body 10 through the inlet panel 120. The inlet panel 120 may include one or more inlet holes 121 communicating with the outside. Air may be introduced through the inlet holes 121 formed in the inlet panel 120 to cool the electronic chamber 60. The inlet hole 121 may be referred to as the first cooling air inlet 121.

The air flowing in through the inlet panel 120 may cool the electronic chamber 60 and then flow back into the cooking chamber 30 to cool a rear surface of the door 20 and finally discharge to a cooling air outlet 93 formed on the upper surface of the main body 10. More particularly, the cooling air outlet 93 may be formed by cutting a portion of the upper surface of the external housing 11.

Referring to FIG. 4, the main body 10 may include a top plate 81 and a front plate 80. For example, the top plate 81 may form an upper surface of the internal housing 12, and the front plate 80 may form a front surface of the internal housing 12.

The control box 100 may be mounted in front of the front plate 80. The electronic chamber 60 may be provided at a rear side of the front plate 80.

The electrical equipment room 60 may include a first electronic chamber 61 and a second electronic chamber 62. Various electrical components may be placed in the electronic chamber 60.

The electronic chamber 60 may be partitioned inside the main body 10 by the front plate 80, the top plate 81, a cooling divider 51, and a circulation plate 56. The electronic chamber 60 may be partitioned into the first electronic chamber 61 and the second electronic chamber 62 by a partition plate 63.

For example, the circulation plate 56 may form a floor of the electronic chamber 60. The circulation plate 56 may be arranged to be spaced apart from the bottom plate 97.

The cooling divider 51 may be disposed at an upper portion of the circulation plate 56 and may have a vertically extending shape. The cooling divider 51 may be provided as a surface of a rear bracket 52, which will be described later. For example, the cooling divider 51 may be the surface facing the partition plate 63.

Because the electronic chamber 60 is partitioned by the circulation plate 56 and the cooling divider 51, oil vapor introduced through the second circulating air intake portion 15 may be prevented from penetrating into the electronic chamber 60. Accordingly, components placed inside the electronic chamber 60 may be protected from oil vapor or other foreign substances.

A cooling fan 71 may be accommodated inside the first electronic chamber 61. The cooling fan 71 may generate an air flow to allow external air to flow into the inlet panel 120.

The control box 100 may be mounted on the front plate 81 to communicate with the first electronic chamber 61. Air flowing into the control box 100 through the inlet holes 121 of the inlet panel 120 may cool the control box 100.

A magnetron 73 and a transformer 74 may be accommodated within the second electronic chamber 62. The magnetron 73 and the transformer 74 may be provided to generate high frequencies. The high frequency generated by the magnetron 73 and the transformer 74 may be supplied into the cooking chamber 30 to heat the food to be cooked.

The partition plate 63 that divides the first electronic chamber 61 and the second electronic chamber 62 may be partially open. The partition plate 63 may include a lower opening (not shown) in communication with the cooling fan 71 such that air drawn into the inlet panel 120 by the cooling fan 71 flows through the first electronic chamber 61 and into the second electronic chamber 62. In addition, the partition plate 63 may include an upper opening (not shown) through which the second electronic chamber 62 and a guide duct 72 communicate.

The air introduced into the second electronic chamber 62 may cool the transformer 74 and the magnetron 73 and then flow into the guide duct 72 mounted on the partition plate 63. The guide duct 72 may be disposed in the first electronic chamber 61 to form a space in which the second electronic chamber 62 and the cooking chamber 30 communicate with each other.

As a result, the air flowing into the guide duct 72 may flow into the inside of the cooking chamber 30 to cool the rear surface of the door 20. Thereafter, the air may flow into an exhaust duct 31, which communicates with an upper surface of the cooking chamber 30, and then be discharged to the outside of the cooking apparatus 1 through the cooling air outlet 93, which communicates with the exhaust duct 31.

In addition to a cooling flow path C that cools the electronic chamber 60 and the door 20, the cooking apparatus 1 may include the circulating flow paths V1 and V2 that draw in, filter, and discharge contaminated air containing oil vapor, etc.

Referring to FIGS. 4 and 5, the cooking apparatus 1 may include circulation fans 41 and 42 that generate a blowing (e.g., suction) force to draw in contaminated air. For example, the circulation fans 41 and 42 may include the first circulation fan 41 and the second circulation fan 42, which are disposed on opposite sides of the cooking chamber 30 with the cooking chamber 30 in between. The first circulation fan 41 and the second circulation fan 42 may be arranged on opposite sides of the main body 10, and thus the overall height of the main body 10 may be reduced, thereby ensuring a larger kitchen space.

Meanwhile, the cooking apparatus 1 may be provided with a plurality of circulating flow paths V1 and V2 inside, having the first circulating flow path V1 being flowed by the first circulation fan 41 and the second circulating flow path V2 being flowed by the second circulation fan 42. Further details thereof will be described later.

The cooking apparatus 1 may include the rear bracket 52. The rear bracket 52 may include a circulation fan receiving portion 521 provided to accommodate the second circulation fan 42.

One side (i.e., the cooling divider 51) of the rear bracket 52 facing the electronic chamber 60 may be provided to partition the electronic chamber 60 and the circulation fan receiving portion 521. The electronic chamber 60 and the circulation fan receiving portion 521 may not be in communication with each other. The rear bracket 52 may include a communication portion 522 that allows to be open to communicate with the circulation fan receiving portion 521. Depending on the shape of the rear bracket 52, the air drawn into the second circulating air intake portion 15 may flow within the main body 10 along the circulating flow path V2.

The first circulation fan 41 may generate a blowing force to allow air to be introduced into the first circulating air intake portion 14 formed on the bottom plate 97. A side plate 89 of the internal housing 12 may be mounted on an upper portion of the first circulation fan 41. A portion of the side plate 89 may be cut to allow the introduced air to flow to the upper portion of the first circulation fan 41. For example, the side plate 89 may include first communication holes 891.

The second circulation fan 42 may generate a blowing force to allow air to be introduced into the second circulating air intake portion 15 formed on the bottom plate 97. The second circulation fan 42 may be disposed in the circulation fan receiving portion 521 of the rear bracket 52. The air introduced through the second circulating air intake portion 15 may move along the rear inside the main body 10 through the communication portion 522 of the rear bracket 52 and flow to an upper portion of the internal housing 12.

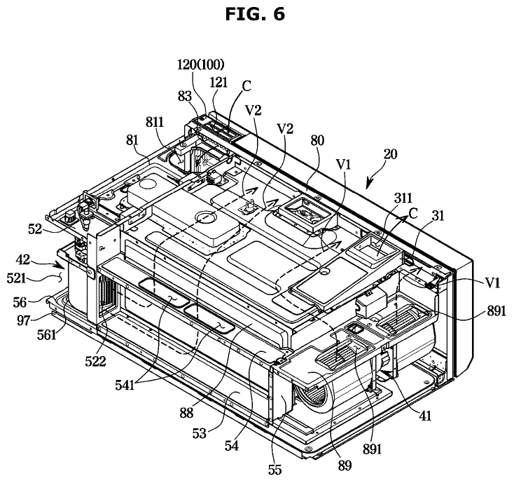

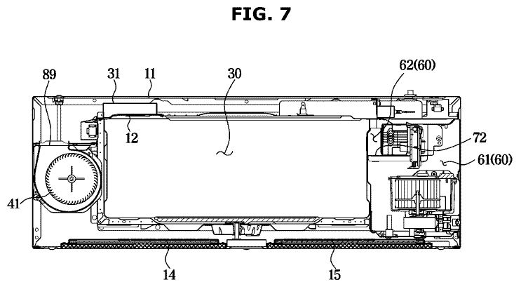

FIG. 6 is a rear perspective view illustrating air flow in the cooking apparatus according to an embodiment of the disclosure with the external housing removed. FIG. 7 is a cross-sectional view illustrating the cooking apparatus according to an embodiment of the disclosure.

In the following, the first circulating flow path V1, the second circulating flow path V2, and the cooling flow path C of the cooking apparatus 1 according to an embodiment of the disclosure will be described.

Referring to FIGS. 5 and 6, contaminated air may be introduced into the main body 10 through the first circulating air intake portion 14 formed in a lower portion of the main body 10. The air introduced into the main body 10 may be filtered and pass through the first circulation fan 41. The air passing through the first circulation fan 41 may flow to the upper portion of the internal housing 12 through the first communication holes 891 of the side plate 89 disposed on the upper portion of the first circulation fan 41. The flowed air may be discharged back to the outside of the cooking apparatus 1 through the first circulating air outlet 911 and the second circulating air outlet 921. This may be referred to as the first circulating flow path V1.

However, as described above, in the case where a separate communication duct is provided and the filtered oil vapor is discharged to the outside, it should be understood that the air introduced into the first circulating air intake portion 14 may be discharged to the outside of the cooking apparatus 1 through the circulating air outlet formed on the ventilation duct panel 94 (not shown).

Referring to FIGS. 4 and 6, contaminated air may be introduced into the main body 10 through the second circulating air intake portion 15 formed in the lower portion of the main body 10. The air introduced into the main body 10 may be filtered and pass through the second circulation fan 42. More particularly, air may introduce into the circulation fan receiving portion 521 of the rear bracket 52 through a through hole 561 formed in the circulation plate 56. The communication portion 522 of the rear bracket 52 may be formed in a portion partitioning between a back plate 95 of the external housing 11 and a rear plate 88 of the internal housing 12. Accordingly, the air introduced into the through hole 561 may flow to a rear side of the internal housing 12 through the communication portion 522.

The cooking apparatus 1 may include a bottom bracket 53, a partition bracket 54 and a circulation divider 55.

The bottom bracket 53 and the partition bracket 54 may be disposed between the external housing 11 and the internal housing 12. More particularly, the bottom bracket 53 and the partition bracket 54 may be disposed on the rear side of the internal housing 12 and extend horizontally. The partition bracket 54 may be disposed on an upper portion of the bottom bracket 53 to face each other.

The circulation divider 55 may be arranged between the external housing 11 and the internal housing 12. More particularly, the circulation divider 55 may be disposed on the rear side of the internal housing 12. The circulation divider 55 may be arranged to face the communication portion 522 of the rear bracket 52.

The partition bracket 54 may include second communication holes 541. Air may flow through the second communication holes 541.

The rear bracket 52, the bottom bracket 53, the partition bracket 54, and the circulation divider 55 may be provided to form a portion of the flow path through which the air introduced into the second circulating air intake portion 15 flows.

The air introduced into the second circulating air intake portion 15 may pass through the through hole 561 of the circulation plate 56, pass through the second circulation fan 42, and pass through the communication portion 522 of the rear bracket 52, and finally flow between the bottom bracket 53 and the partition bracket 54.

At this time, the circulation divider 55 may be closed without an open portion to be disposed between the partition bracket 54 and the bottom bracket 53. Accordingly, the flowing air may flow to the rear upper portion of the internal housing 12 through the second communication holes 541 of the partition bracket 54.

The air flowing into the upper portion of the internal housing 12 through the second communication holes 541 may be discharged back to the outside of the cooking apparatus 1 through the first circulating air outlet 911 and the second circulating air outlet 921 formed on the front upper portion of the main body 10. This may be referred to as the second circulating flow path V2.

However, as described above, in the case where a separate communication duct is provided and the filtered oil vapor is discharged to the outside, it should be understood that the air introduced into the second circulating air intake portion 15 may be discharged the outside of the cooking apparatus 1 through the circulating air outlet formed in the ventilation duct panel 94.

Since the circulation divider 55 is provided to be closed, the air introduced by the first circulation fan 41 and the air introduced by the second circulation fan 42 may flow in a separated state in the lower portion of the internal housing 12 and be joined in the upper portion of the internal housing 12.

Referring to FIGS. 6 and 7, the air flowing into the inlet panel 120 may flow through the first electronic chamber 61 and the second electronic chamber 62 to cool various electrical equipment. More particularly, the air flowing into the inlet holes (first cooling air inlet) 121 of the inlet panel 120 may pass through plate holes (second cooling air inlet) 83 formed in the front plate 80 and flow into the interior of the main body 10. Thereafter, the air may flow into the electronic chamber 60 through a top opening 811 formed in the top plate 81 of the internal housing 12.

The air flowing into the first electronic chamber 61 may flow into the second electronic chamber 62 through the cooling fan 71, and the air flowing into the second electronic chamber 62 may be guided into the interior of the cooking chamber 30 by the guide duct 72 communicating with the side of the cooking chamber 30. The air guided into the interior of the cooking chamber 30 may cool the rear surface of the door 20 and then flow into the exhaust duct 31 communicating with an upper portion of the cooking chamber 30. The exhaust duct 31 may be provided to communicate with the cooling air outlet 93. Accordingly, the completely cooled air may be discharged to the outside of the cooking apparatus 1 through the cooling air outlet 93. This may be referred to as the cooling flow path C.

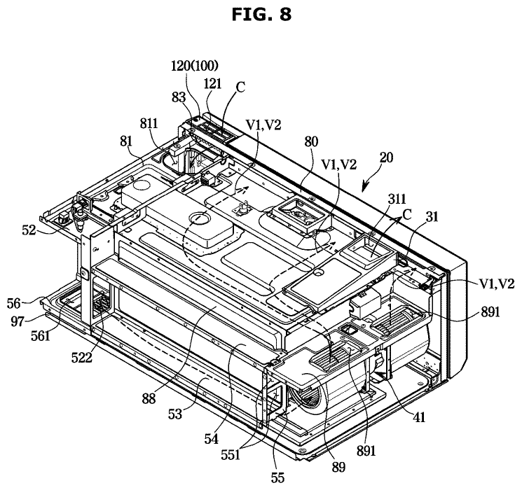

FIG. 8 is a rear perspective view illustrating airflow in a cooking apparatus according to another embodiment of the disclosure with the external housing removed.

The cooking apparatus according to another embodiment of the disclosure may include the single circulation fan 41 in contrast to the cooking apparatus 1 according to an embodiment of the disclosure. More specifically, the cooking apparatus may be provided to include only the first circulation fan 41.

Furthermore, the cooking apparatus according to another embodiment of the disclosure may include the same configuration as the cooking apparatus 1 according to an embodiment of the disclosure except that the circulation divider 55 and the partition bracket 54 are arranged in a different configuration. Therefore, the same configuration may include the same reference numerals, and the same description as the cooking apparatus 1 described above may be omitted.

The cooking apparatus according to another embodiment of the disclosure may include the first circulation fan 41 disposed between the internal housing 12 and the external housing 11. Through the first circulation fan 41, air may be drawn into the first circulation air inlet and the second circulation air inlet.

More specifically, the air introduced into the first circulation air inlet may pass through the first circulation fan 41 and into the first communication holes 891 of the side plate 89. The air that has passed through the first communication holes 891 may be discharged to the outside of the cooking apparatus through the first circulating air outlet 911 of the service panel 91 and the second circulating air outlet 921 of the discharge panel 92.

However, as described above, in the case where a separate communication duct (not shown) is provided and the filtered oil vapor is discharged to the outside, it should be understood that the air introduced into the first circulating air inlet may be discharged the outside of the cooking apparatus through the circulating air outlet formed in the ventilation duct panel 94.

The air introduced into the second circulating air inlet may pass through the through hole 561 of the circulation plate 56 and flow into the space between the partition bracket 54 and the bottom bracket 53 through the communication portion 522 of the rear bracket 52.

At this time, the partition bracket 54 may be provided to be closed without an open portion. More particularly, in contrast to the cooking apparatus 1 according to an embodiment of the disclosure, the second communication hole 541 may not be formed in the partition bracket 54.

However, the partition bracket 54 may be closed and a second communication hole 551 may be formed in the circulation divider 55. Accordingly, the air introduced into the second circulation air inlet may flow into the space between the partition bracket 54 and the bottom bracket 53 and flow toward the first circulation fan 41 through the second communication holes 551 of the circulation divider.

Thereafter, the air that has passed through the first circulation fan 41 may flow to the upper portion of the internal housing 12 through the first communication holes 891 of the side plate 89. The flowing air may be discharged to the outside of the cooking apparatus through the first circulating air outlet 911 of the service panel 91 and the second circulating air outlet 921 of the discharge panel 92.

However, as described above, in the case where a separate flue duct (not shown) is provided and the filtered oil vapor is discharged to the outside, it should be understood that the air introduced into the second circulating air inlet may be discharged the outside of the cooking apparatus through the circulating air outlet formed in the ventilation duct panel 94.

In contrast to the cooking apparatus 1 according to an embodiment of the disclosure, the cooking apparatus according to another embodiment of the disclosure may close the partition bracket 54 and open the circulation divider 55, and thus air may be drawn in through the first and second circulating air inlets using only the first circulation fan 41. Accordingly, manufacturing costs may be reduced by producing cooking apparatus with a simpler structure. In addition, only the configurations of the partition bracket 54 and the circulation divider 55 may be replaced according to the user's needs, eliminating the need for complex changes to the internal design depending on the number of circulation fans.

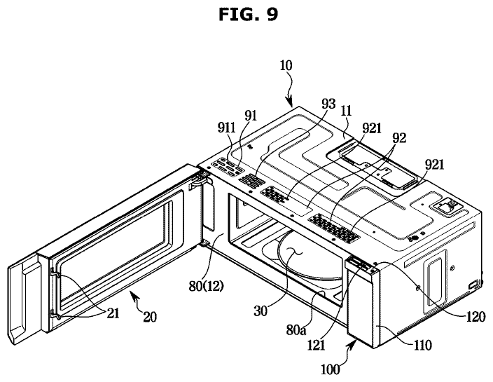

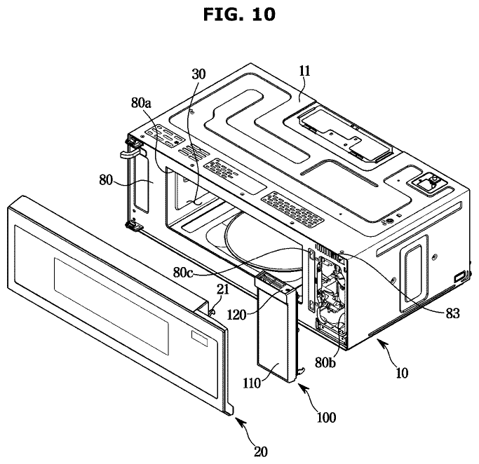

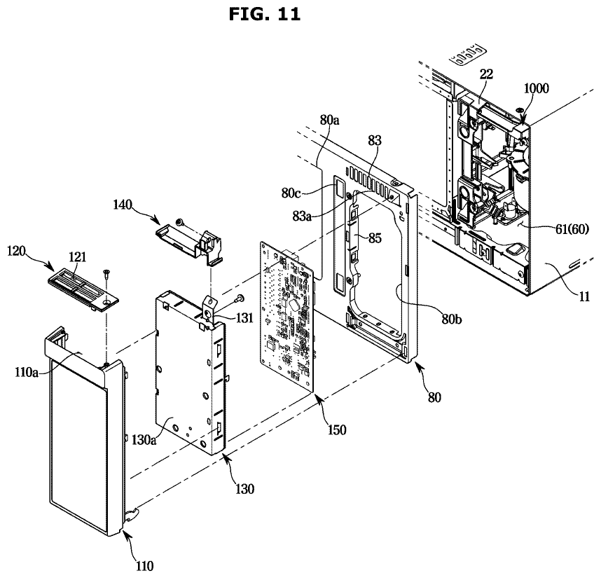

FIG. 9 is a view illustrating an open state of the door of the cooking apparatus according to an embodiment of the disclosure. FIG. 10 is an exploded perspective view illustrating the door, the control box, and the main body of the cooking apparatus according to an embodiment of the disclosure. FIG. 11 is an exploded perspective view illustrating the control box and the main body of the cooking apparatus according to an embodiment of the disclosure.

Referring to FIGS. 9 to 11, the main body 10 may include the front plate 80.

The front plate 80 may be placed in front of the cooking chamber 30. The front plate 80 may be placed in front of the electronic chamber 60.

The front plate 80 may include a first opening 80a communicating with the cooking chamber 30 and a second opening 80b communicating with the electronic chamber 60. The second opening 80b may also be referred to as a front opening 80b.

The front plate 80 may include an insertion portion 80c into which a latch protrusion 21 of the door 20 is inserted. For example, the insertion portion 80c may be arranged between the first opening 80a and the second opening 80b. The latch protrusion 21 may be inserted into the main body 10 through the insertion portion 80c and locked by a latch body 22. With the latch protrusion 21 locked to the latch body 22, the door 20 may be maintained in a closed state of the cooking chamber 30.

The front plate 80 may include the plate holes 83. The plate holes 83 may be in communication with the control box 100. The plate holes 83 may be in communication with the electronic chamber 60. The plate holes 83 may guide the air flowing in from the inlet panel 120 of the control box 100 to the electronic chamber 60. The plate holes 83 may also be referred to as the guide hole.

The cooking apparatus 1 may include the control box 100, which may be detachably mounted on the front side of the main body 10. The control box 100 may be located in front of the front plate 80. The rear side of the control box 100 may be adjacent to the electronic chamber 60. The rear side of the control box 100 may be adjacent to the second opening 80b.

The control box 100 may be provided to control an operation of the cooking apparatus 1. The control box 100 may control various electrical components arranged in the electronic chamber 60.

The control box 100 may include a case 110 and the inlet panel 120 coupled to an upper portion of the case 110.

Referring to FIG. 11, the control box 100 may further include a bracket panel 130, a guide member 140, and a circuit board 150.

The case 110 may accommodate the bracket panel 130, the guide member 140, and the circuit board 150. The case 110 may be provided to form the exterior of the control box 100.

The case 110 may include an opening 110a having an open upper portion. The inlet panel 120 may be provided to cover the opening 110a.

The inlet panel 120 may be provided on the upper portion of the case 110. The inlet panel 120 may be provided to cover the opening 110a. The inlet panel 120 may be provided to cover the guide member 140 and a portion of the main body 10. For example, the inlet panel 120 may prevent the plate holes 83 formed in the front plate 80 from being exposed to the outside.

The inlet panel 120 may be detachably coupled to the upper portion of the case 110. For example, the case 110 may be screw-coupled to the inlet panel 120. However, this is only an example, and various other coupling arrangements may be employed. Alternatively, the inlet panel 120 may be formed integrally with the case 110.

As described above, the inlet panel 120 may be in communication with the outside. For example, the inlet panel 120 may include the inlet holes 121 through which air flows in from the outside to cool the electronic chamber 60. The inlet hole 121 may also be referred to as the first cooling air inlet.

Air introduced through the inlet holes 121 may be introduced into the electronic chamber 60 through the plate holes 83 formed in the front plate 80. The plate hole 83 may also be referred to as the second cooling air inlet.

The air introduced into the electronic chamber 60 may cool the electronic chamber 60. As a result, the temperature of various electrical components placed in the electronic chamber 60 may be lowered, and the stability of the electrical components may be increased.

The bracket panel 130 may be accommodated within the case 110. The bracket panel 130 may be provided to accommodate the circuit board 150. For example, the bracket panel 130 may have a rear open shape to form a space in which the circuit board 150 is accommodated.

The guide member 140 may be detachably coupled to an upper portion of the bracket panel 130. For example, the bracket panel 130 may include a coupling portion 131 extending toward the guide member 140, and the coupling portion 131 may be screw-coupled with the guide member 140. However, this is only an example, and various other coupling arrangements may be employed. Alternatively, the bracket panel 130 may be formed integrally with the guide member 140.

The bracket panel 130 may be arranged to be spaced apart from the case 110. For example, a front surface 130a of the bracket panel 130 may be arranged to be spaced apart from a rear surface 110b of the case 110. As a result, a space through which moisture may flow may be formed between the bracket panel 130 and the case 110. Further details thereof will be described later.

The guide member 140 may be accommodated within the case 110. The guide member 140 may be disposed on a lower side of the inlet panel 120. The guide member 140 may be disposed on an upper side of the bracket panel 130. The guide member 140 may be detachably coupled to the upper portion of the bracket panel 130.

The guide member 140 may guide moisture entering the control box 100. For example, the guide member 140 may include a shape that slopes downwardly toward the front to smoothly guide moisture forward. Further details thereof will be described later.

In FIG. 11, the case 110, the inlet panel 120, the bracket panel 130, and the guide member 140 are shown as being formed and assembled as separate components, but are not limited thereto. The case 110, the inlet panel 120, the bracket panel 130, and the guide member 140 may be formed integrally. Alternatively, some of the components of the case 110, the inlet panel 120, the bracket panel 130, or the guide member 140 may be formed integrally.

The circuit board 150 may be accommodated within the bracket panel 130. Various electronic components, etc. may be mounted or connected to the circuit board 150. At least some of the components accommodated within the main body 10 may be electrically connected to the circuit board 150. For example, electrical equipment placed in the electronic chamber 60 may be electrically connected to the circuit board 150. To enable such connection, the front plate 80 may be provided with the front opening 80b. Furthermore, access to the interior of the electronic chamber 60 may be available through the front opening 80b.

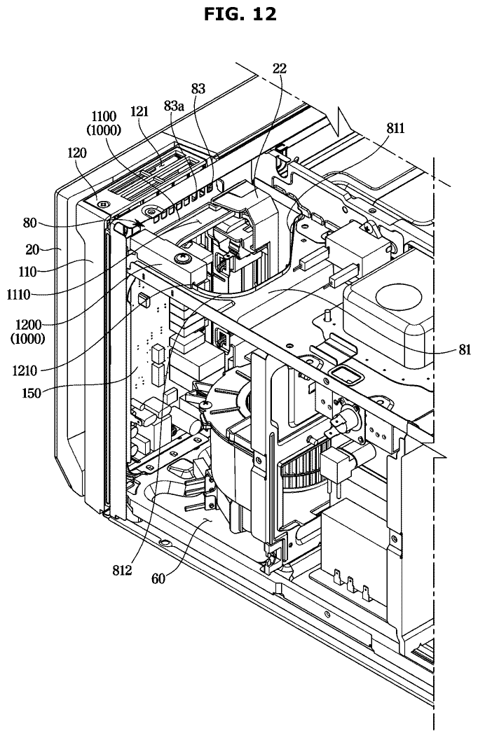

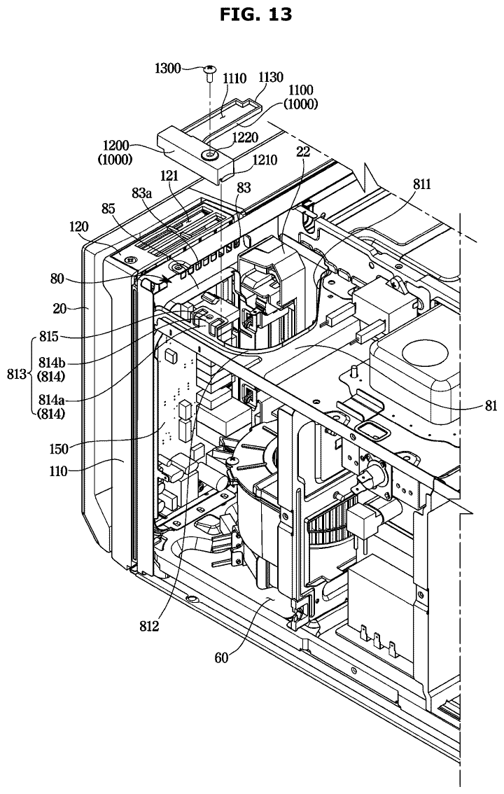

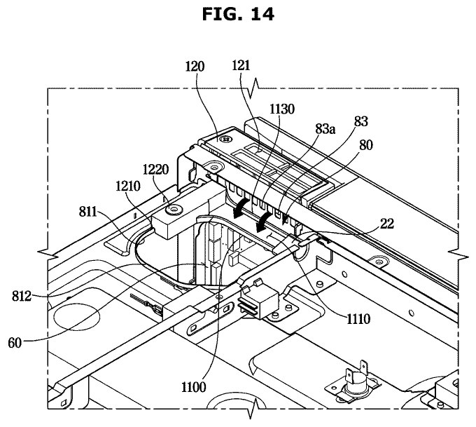

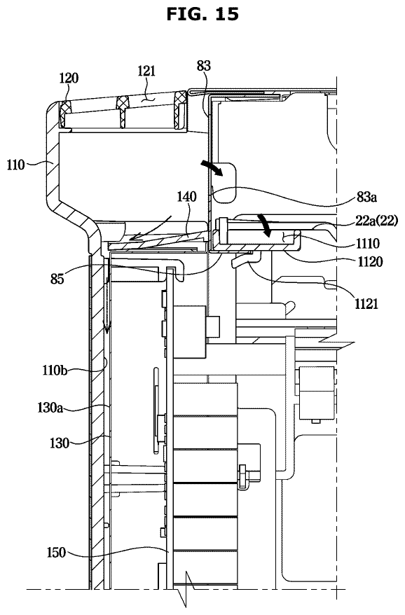

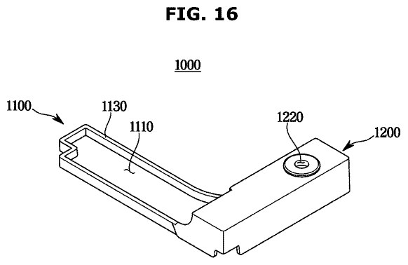

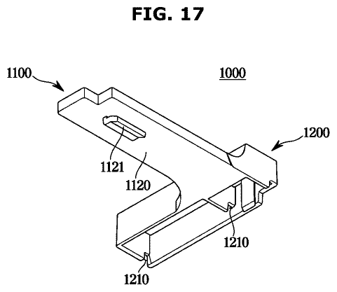

FIG. 12 is a view illustrating a state in which the external housing is removed from the cooking apparatus according to an embodiment of the disclosure from the rear. FIG. 13 is a view illustrating a disassembled state of a moisture inflow prevention member in the cooking apparatus shown in FIG. 12. FIG. 14 is an enlarged view of a portion of the cooking apparatus shown in FIG. 12 from another direction. FIG. 15 is a cross-sectional view illustrating the control box of the cooking apparatus according to an embodiment of the disclosure coupled to the main body. FIG. 16 is a perspective view illustrating the moisture inflow prevention member of the cooking apparatus according to an embodiment of the disclosure. FIG. 17 is a bottom perspective view illustrating the moisture inflow prevention member of a cooking apparatus according to an embodiment of the disclosure.

Referring to FIGS. 12 to 14, the main body 10 may include the top plate 81. The top plate 81 may be placed above the electronic chamber 60. The top opening 811 communicating with the electronic chamber 60 may be formed in the top plate 81. The top plate 81 may further include an upper flange 812 extending upward from an edge forming the top opening 811.

As described above, to cool the electronic chamber 60, external air may be introduced into the electronic chamber 60 through the inlet panel 120 and the front plate 80. At this time, in addition to air, moisture (or humidity) may flow into the main body 10. For example, the moisture flowing into the control box 100 through the inlet holes 121 of the inlet panel 120 may flow into the plate holes 83 of the front plate 80. The moisture flowing in through the plate holes 83 may pass through the top opening 811 of the top plate 81 and flow into the electronic chamber 60. If moisture enters the electronic chamber 60, it may cause malfunction, damage to parts, mold growth, etc. of the cooking apparatus, so it is necessary to prevent moisture from entering the electronic chamber 60.

To this end, as shown in FIGS. 12 to 15, the cooking apparatus 1 may include a moisture inflow prevention member 1000. The moisture inflow prevention member 1000 may prevent or block moisture from entering the electronic chamber 60. For example, the moisture inflow prevention member 1000 may prevent moisture introduced from the inlet panel 120 from entering the electronic chamber 60 through the plate holes 83.

The moisture inflow prevention member 1000 may be provided on an upper side of the electronic chamber 60. For example, the moisture inflow prevention member 1000 may be provided on the upper side of the first electronic chamber 60. The moisture inflow prevention member 1000 may be provided at the rear side of the front plate 80.

The moisture inflow prevention member 1000 may include a coupling portion 1200 and a tray 1100.

The coupling portion 1200 of the moisture inflow prevention member 1000 may be provided to be coupled to the main body 10. The moisture inflow prevention member 1000 may be stably fixed within the main body 10 by the coupling portion 1200.

The coupling portion 1200 may be coupled to the top plate 81.

The coupling portion 1200 may be coupled to the upper flange 812 extending upward from the edge forming the top opening 811. For example, the coupling portion 1200 may include a flange groove 1210 seated on the upper flange 812.

The top plate 81 may include a coupling bracket 813 coupled to the moisture inflow prevention member 1000. For example, the coupling bracket 813 may include a bracket body 814 extending toward the moisture inflow prevention member 1000 and a bracket hole 815 penetrating the bracket body 814. The coupling portion 1200 may include a coupling hole 1220 corresponding to the bracket hole 815.

In the drawings, the single bracket hole 815 and the single coupling hole 1220 are shown, but are not limited thereto. Two or more of each may be provided.

The bracket body 814 may include a first extension 814a extending in a first direction and a second extension 814b extending in a second direction. The second direction may be a direction that intersects the first direction. For example, the first direction may be a vertical direction (Z direction), and the second direction may be a left-right direction (Y direction).

The bracket hole 815 may be formed in the second extension 814b of the bracket body 814, but is not limited thereto. The bracket hole 815 may be formed in the first extension 814a. In this case, the coupling hole 1220 may be formed in a side surface of the coupling portion 1200 corresponding to the first extension 814a.

For example, the bracket hole 815 and the coupling hole 1220 may be screw-coupled together through a separate fastening member 1300. However, this is only an example, and various other arrangements may be employed.

The tray 1100 of the moisture inflow prevention member 1000 may be provided to allow moisture entering through the plate hole 83 to be collected. The tray 1100 may include a receiving portion 1110 therein that receives moisture entering through the plate hole 83.

The tray 1100 may be located adjacent to a lower end 83a of the plate hole 83. For example, an upper end 1130 of the tray 1100 may be located lower than the lower end 83a of the plate hole 83. As a result, the tray 1100 may receive moisture that falls downward through the plate hole 83.

The front plate 80 may include the front opening 80b communicating with the electronic chamber 60. The front opening 80b may be located lower than the plate hole 83. The front plate 80 may include a rear flange 85 extending rearward from an edge forming the front opening 80b.

The tray 1100 may include a fitting portion 1121 into which a portion of the rear flange 85 is inserted. The fitting portion 1121 may be formed on a lower surface 1120 of the tray 1100. For example, the fitting portion 1121 may include an elastic material. In other words, in the moisture inflow prevention member 1000, the tray 1100 may also be coupled to the main body 10, in addition to the coupling portion 1200. As a result, the moisture inflow prevention member 1000 may be more stably attached to the main body 10, thereby improving assembly efficiency.

A portion of the tray 1100 may be accommodated within the latch body 22. For example, a portion of the upper end 1130 of the tray 1100 may be provided to be caught by an upper inner surface 22a of the latch body 22. As a result, the tray 1100 may be prevented from separating, thereby improving the assembly of the moisture inflow prevention member 1000.

Referring to FIGS. 12 to 14, the coupling portion 1200 may have a shape extending in the front-rear direction (X direction). The tray 1100 may have a shape extending in the left-right direction (Y direction). With this shape, the moisture inflow prevention member 1100 may receive moisture entering through the plate hole 83 while not blocking the top opening 811 as much as possible. In other words, it is possible to block moisture from entering the electronic chamber 60 without interfering with a flow of air flowing in from the outside.

Meanwhile, the coupling portion 1200 and the tray 1100 may be formed integrally, but are not limited thereto. Alternatively, the coupling portion 1200 and the tray 1100 may be assembled as separate components.

Referring to FIGS. 14 and 15, a structure of the cooking apparatus 1 that prevents moisture from entering the control box 100 and the electronic chamber 60 will be described in more detail.

Moisture from outside the cooking apparatus 1 may enter the control box 100 through the inlet holes 121 of the inlet panel 120.

The moisture introduced through the inlet holes 121 may be guided forward by the guide member 140. For example, the moisture introduced through the inlet holes 121 may flow downward between the rear surface 110b of the case 110 and the front surface 130a of the bracket panel 130 by the guide member 140 (see dash-dotted arrow in FIG. 15). As a result, the moisture entering from the inlet panel 120 may not flow into the circuit board 150 due to the guide member 140. In other words, the guide member 140 may protect the circuit board 150 from moisture entering the control box 100.

Among the moisture introduced through the inlet holes 121, moisture that is not guided forward by the guide member 140 may flow into the plate hole 83. For example, the moisture introduced through the inlet holes 121 may pass directly through the plate holes 83 without passing through the guide member 140, or pass through the plate holes 83 by bouncing on the guide member 140. The moisture inflow prevention member 1000 may be disposed on the upper side of the electronic chamber 60 to prevent moisture introduced through the plate holes 83 from entering the electronic chamber 60. For example, the tray 1100 of the moisture inflow prevention member 1000 may receive moisture flowing downward through the plate holes 83. As a result, moisture passing through the plate holes 83 may be corrected in the tray 1100 and be prevented from entering the electronic chamber 60. In other words, the moisture inflow prevention member 1000 may protect various electrical components located in the electronic chamber 60 from moisture flowing into the main body 10.

While the present disclosure has been particularly described with reference to exemplary embodiments, it should be understood by those of skilled in the art that various changes in form and details may be made without departing from the spirit and scope of the present disclosure.

What is claimed is:

1. A cooking apparatus, comprising:
a main body including:
an electronic chamber; and
a front plate disposed on a front side of the electronic chamber;
a control box detachably mounted on a front side of the front plate, the control box including:
a case; and
an inlet panel disposed on an upper portion of the case to be in communication with outside of the main body;
a plate hole formed in the front plate to communicate with the control box and the electronic chamber; and
a moisture inflow prevention member disposed on an upper side of the electronic chamber to prevent moisture introduced from the inlet panel from entering the electronic chamber through the plate hole.

2. The cooking apparatus of claim 1, wherein the moisture inflow prevention member further comprises:
a coupling portion to be coupled to the main body; and
a tray disposed adjacent to a lower end of the plate hole and to collect moisture introduced through the plate hole.

3. The cooking apparatus of claim 2, wherein the main body further comprises:
a top plate disposed on the upper side of the electronic chamber; and
a top opening formed in the top plate to communicate with the electronic chamber, and
the coupling portion of the moisture inflow prevention member is configured to be coupled to the top plate.

4. The cooking apparatus of claim 3, wherein the top plate further comprises
an upper flange extending upward from an edge forming the top opening, and
the coupling portion further comprises a flange groove seated on the upper flange.

5. The cooking apparatus of claim 3, wherein the top plate further comprises:
a coupling bracket including a bracket body extending toward the moisture inflow prevention member; and
a bracket hole penetrating the bracket body, and
the coupling portion further comprises a coupling hole corresponding to the bracket hole.

6. The cooking apparatus of claim 5, wherein the bracket body further comprises:
a first extension extending in a first direction; and
a second extension extending in a second direction intersecting the first direction, and
the bracket hole is formed in the second extension.

7. The cooking apparatus of claim 2, wherein the front plate further comprises:
a front opening communicating with the electronic chamber and formed on a lower side of the plate hole; and
a rear flange extending rearward from an edge forming the front opening, and
the tray further comprises a fitting portion formed on a lower surface of the tray to allow a portion of the rear flange to be inserted.

8. The cooking apparatus of claim 2, further comprising:
a cooking chamber partitioned from the electronic chamber within the main body;
a door configured to open or close the cooking chamber, and including a latch protrusion; and
a latch body disposed within the electronic chamber and configured to lock the latch protrusion,
wherein a portion of the tray of the moisture inflow prevention member is to be accommodated in the latch body.

9. The cooking apparatus of claim 1, wherein the inlet panel further comprises
an inlet hole formed therein and through which air flows in from outside of the main body, and
the plate hole is configured to guide the air has flown in from the inlet hole of the inlet panel to the electronic chamber so as to cool the electronic chamber.

10. The cooking apparatus of claim 1, further comprising a guide member disposed on a lower side of the inlet panel in the case, the guide member spaced apart from a rear surface of the case and to guide moisture flowing in from the inlet panel forward.

11. The cooking apparatus of claim 10, wherein the guide member has a shape inclined downwardly forward.

12. The cooking apparatus of claim 10, wherein the plate hole is located above the guide member.

13. The cooking apparatus of claim 10, wherein the control box further comprises a bracket panel to accommodate a circuit board, the bracket panel being coupled to a lower portion of the guide member to be spaced apart from the rear surface of the case, and
the moisture guided by the guide member flows downwardly between the case and the bracket panel.

14. The cooking apparatus of claim 2, wherein the coupling portion has a shape extending in a front-rear direction, and
the tray has a shape extending in a left-right direction.

15. The cooking apparatus of claim 7, wherein the fitting portion includes an elastic material.

16. A cooking apparatus including:
a cooking chamber;
an electronic chamber partitioned from the cooking chamber;
a door to open or close the cooking chamber;
a control box covered by the door and detachably mounted on a front side of the electronic chamber, the control box including:
a case; and
an inlet panel to cover an upper portion of the case and to allow air to flow in from outside;
a guide hole to guide air introduced from the inlet panel to the electronic chamber; and
a moisture inflow prevention member disposed on a lower side of the guide hole and configured to prevent moisture from entering the electronic chamber through the guide hole.

17. The cooking apparatus of claim 16, wherein the moisture inflow prevention member further includes a tray to collect moisture introduced through the guide hole.

18. The cooking apparatus of claim 17, wherein the control box further includes:
a bracket panel disposed within the case to accommodate a circuit board; and
a guide member coupled to an upper portion of the bracket panel, and to guide moisture introduced through the inlet panel between the case and the bracket panel.

19. A cooking apparatus including:
a main body attached to an external structure;
an electronic chamber formed in the main body to receive electrical components;
a control box configured to receive a circuit board electrically connectable to the electrical components, the control box including:
a case; and
an inlet panel disposed on an upper portion of the case and configured to communicate with outside; and
a moisture inflow prevention member provided in the electronic chamber to prevent moisture from entering the electronic chamber from the inlet panel of the control box.

20. The cooking apparatus of claim 19, wherein the main body includes a front plate arranged between the electronic chamber and the control box,
the front plate forming a plate hole communicating with the inlet panel, and
the moisture inflow prevention member is adjacent to a lower end of the plate hole.
